(19) United States
(12) Patent Application Publication
(10) Pub. No.: US 2015/0261890 A1
(43) Pub. Date: Sep. 17, 2015

(54) MULTI-LEVEL STRUCTURES IN CAD MODELS

(71) Applicant: Siemens Product Lifecycle Management Software Inc., Plano, TX (US)

(72) Inventors: Howard Charles Duncan Mattson, Cambridge (GB); Douglas Joseph King, Peterborough (GB); Michael John Gibbens, Cambridge (GB); Yanong Zhu, Cambridge (GB)

(73) Assignee: SIEMENS PRODUCT LIFECYCLE MANAGEMENT SOFTWARE INC., Plano, TX (US)

(21) Appl. No.: 14/216,073

(22) Filed: Mar. 17, 2014

(51) Int. Cl. G06F 17/50

(52) U.S. Cl. CPC G06F 17/50

(57) ABSTRACT

Methods for product data management and corresponding systems and computer-readable mediums. A method includes receiving a CAD model including a plurality of input features and initializing a data structure representing multi-level structures in the CAD model. The method includes identifying at least two equal groups of the plurality of input features and applying a single-level structure recognition process on the groups of features to produce detected structures such as patterns, mirrors etc. The method includes populating the data structure according to the detected structures and storing the data structure as associated with the CAD model.

### CROSS-REFERENCE TO OTHER APPLICATION

This application has some subject matter in common with, but is otherwise unrelated to, U.S. patent application Ser. No. 13/907,034, filed May 31, 2013, which is hereby incorporated by reference.

### TECHNICAL FIELD

The present disclosure is directed, in general, to computer-aided design, visualization, and manufacturing systems (“CAD systems”), product lifecycle management (“PLM”) systems, and similar systems, that manage data for products and other items (collectively, “Product Data Management” systems or PDM systems).

### BACKGROUND OF THE DISCLOSURE

CAD systems are useful for designing and manufacturing products. Improved systems are desirable.

### SUMMARY OF THE DISCLOSURE

Various disclosed embodiments include methods for product data management and corresponding systems and computer-readable mediums. A method includes receiving a CAD model including a plurality of input features and initializing a data structure representing multi-level structures in the CAD model. The method includes identifying at least two equal groups of the plurality of input features and applying a single-level structure recognition process on the groups of features to produce detected structures. The method includes populating the data structure according to the detected structures and storing the data structure as associated with the CAD model.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIGS. 2A-2E illustrate possible multi-level structures and how they can be processed in accordance with disclosed embodiments;

FIGS. 3A-3D illustrate examples of pattern-finding in accordance with disclosed embodiments;

FIGS. 4A-4B illustrate an example of pattern splitting in accordance with disclosed embodiments;

FIG. 5 illustrates a data structure representation of a multi-level pattern in accordance with disclosed embodiments;

FIGS. 6A-6B illustrates a more complex structure of a multi-level pattern and mirror in accordance with disclosed embodiments;

FIGS. 7A-7E illustrate behavior modes in accordance with disclosed embodiments;

FIGS. 8A-8C illustrate examples of multi-level patterns incorporating these types of structures;

FIGS. 9A-9C illustrate alignment in circular patterns in accordance with disclosed embodiments;

FIGS. 10A-10C illustrate examples of multi-level structures involving mirrors in accordance with disclosed embodiments; and

FIG. 11 depicts a flowchart of a process in accordance with disclosed embodiments.

### DETAILED DESCRIPTION

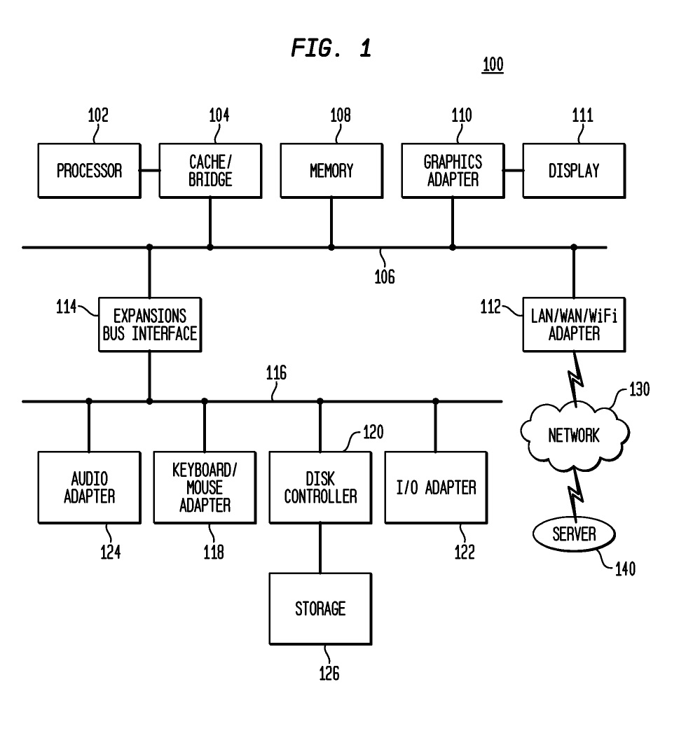

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments include systems and methods for discovering, representing, and controlling behavior of multi-level or hierarchical structures in two-dimensional (2D) and three-dimensional (3D) feature sets. Techniques disclosed herein can be advantageously used in any system where structure is necessary to produce efficient and intuitive behavior. As used herein, a “structure” broad regularity in features or combinations of features in a 2D or 3D feature sets and models, including patterns, mirror arrangements, and others, and combinations of these structures.

FIG. 1 depicts a block diagram of a data processing system in which an embodiment can be implemented, for example as a CAD system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Geometric features often occur in multi-level structured arrangements for aesthetic or functional reasons. In addition to recognition of single level grid structures, if 2D or 3D model data exhibits a multi-level structure and this structure is not recognized, then the system will behave inefficiently and model editing behavior will be unlikely to match user expectations.

Disclosed embodiments include techniques for discovering hierarchical or multi-level structure within sets of features, using proximity as primary grouping indicator, plus the representation of these structures and the control of the modes of behavior when edits are made to the model. Multi-level structures include CAD models that have “patterns of patterns,” that is, groups of elements that have a placement, orientation, or other defined relationship, where the groups themselves form a pattern with other groups.

While the examples and discussion below is directed to 2D models for simplicity of description and illustration, the principles and processes described herein apply to 3D models as well.

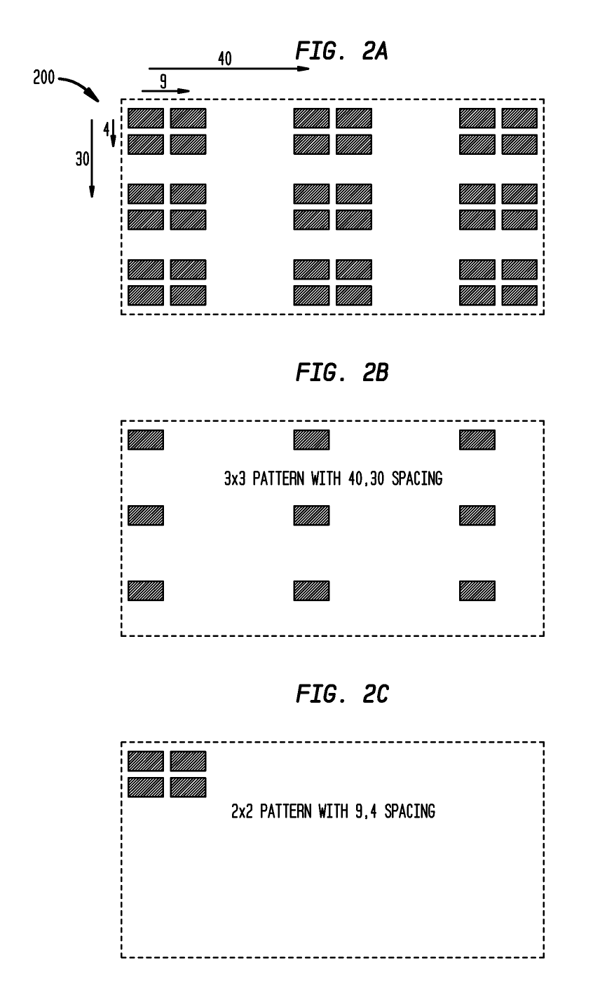

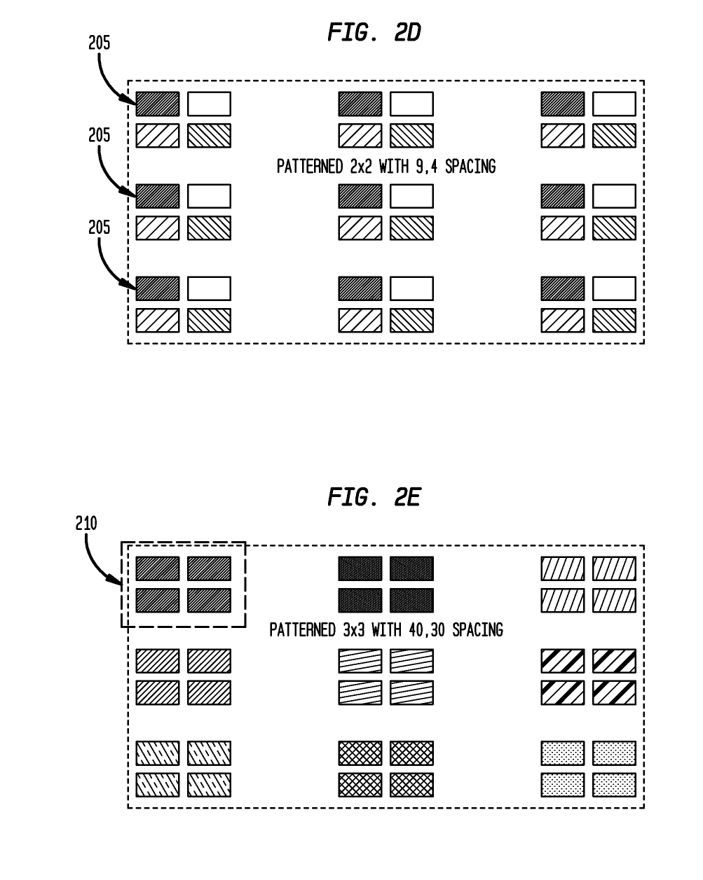

FIGS. 2A-2E illustrate possible multi-level structures and how they can be processed. Often there are multiple possible underlying multi-level structures that could represent a given arrangement. For example, FIG. 2A illustrates a model 200 that can be built up as a pattern of patterns as two alternative structures. The spacing illustrated shows that the individual blocks in each group are spaced at nine units horizontally and four units vertically (9,4 spacing), while the upper-left element in each group are spaced from each other at 40 units horizontally and 30 units vertically (40,30 spacing)

The first structure, illustrated by FIGS. 2B and 2D, uses a lower level 3×3 pattern of the feature with 40,30 spacing (2B) and this pattern is then repeated in a 2×2 pattern with 9,4 spacing (2D).

The second, alternative structure, illustrated by FIGS. 2C and 2E, uses a lower level 2×2 pattern of the feature with 9,4 spacing (2C) and this pattern is then repeated in a 3×3 pattern with 40,30 spacing. So, while the results are similar, there is a choice in how the multi-level structure is created. Various embodiments can identify and represent structure by proximity first. In this example, this means choosing the approach illustrated in FIG. 2E, where the close 2×2 pattern is most tightly bound. This generally corresponds to the human interpretation and results in behavior consistent with this view.

The system can detect multi-level structures in object models using extended single-level recognition. In some cases, the system uses pattern and structure recognition that is applied repeatedly and recursively and can be adjusted or refined input at each stage.

When using basic pattern recognition, the flexible concept of equality is used to determine when two features or sub-patterns are to be considered appropriate peers within a pattern.

Dependent on the application and specific implementation, the notion of equality may vary quite widely. At one extreme, for example, no real geometric equality may be required and the objects' notional centers are simply required to lie in the positions dictated by the structure form. A notional center is the “center” of the group of features, even if there is no specific edge, vertex, or other feature at that point.

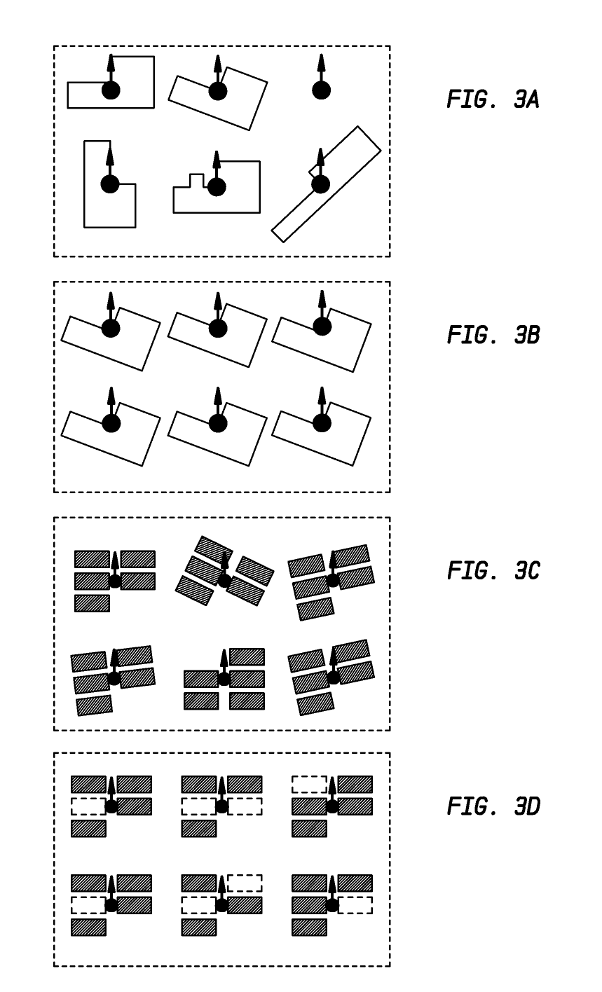

FIGS. 3A-3D illustrate examples of pattern-finding. For example, a rectangular pattern of features may not require equal alignment or even equal shape. FIG. 3A illustrates an example where a feature structure is found using common notional “centers” and directions, shown by circles with connected arrows, which indicate that the differently-shaped features should be treated as a structure. These figures also illustrate notional centers.

In other cases, and according to preferences that can be customized by a user, the system can apply a geometric bias in pattern-finding. FIG. 3B illustrates an example using a geometric bias, so that feature alignment and shape play a part in the choice of equality measure and suggest more strongly the recognition of cases. That is, the similar shapes and similar alignments of the features can be recognized and considered by the system in determining if the multiple features can be treated as a common structure.

The system can apply the same analysis of equality for membership of all types of structures including circular patterns, mirrors, etc. and also at all levels in multi-level structures. For example, when considering a pattern of patterns, the lower level patterns' centers must lie on the higher level pattern grid, but the choice of equality determines how the allowable candidates are chosen. FIG. 3C illustrates an example of a discovered pattern of patterns based on a loose equality of pattern centers.

The system can also apply a stricter geometric equivalence that requires full alignment and equal boundary size, but allow for missing features. FIG. 3D illustrates an example of a discovered pattern of patterns with a strict geometric equivalence yet allowing missing features. The “missing” features in the individual patterns are represented by the dashed boxes, and show that other than the missing features, each of the patterns is equivalent.

As illustrated above, the equality test applied by the system is highly customizable according to user preferences.

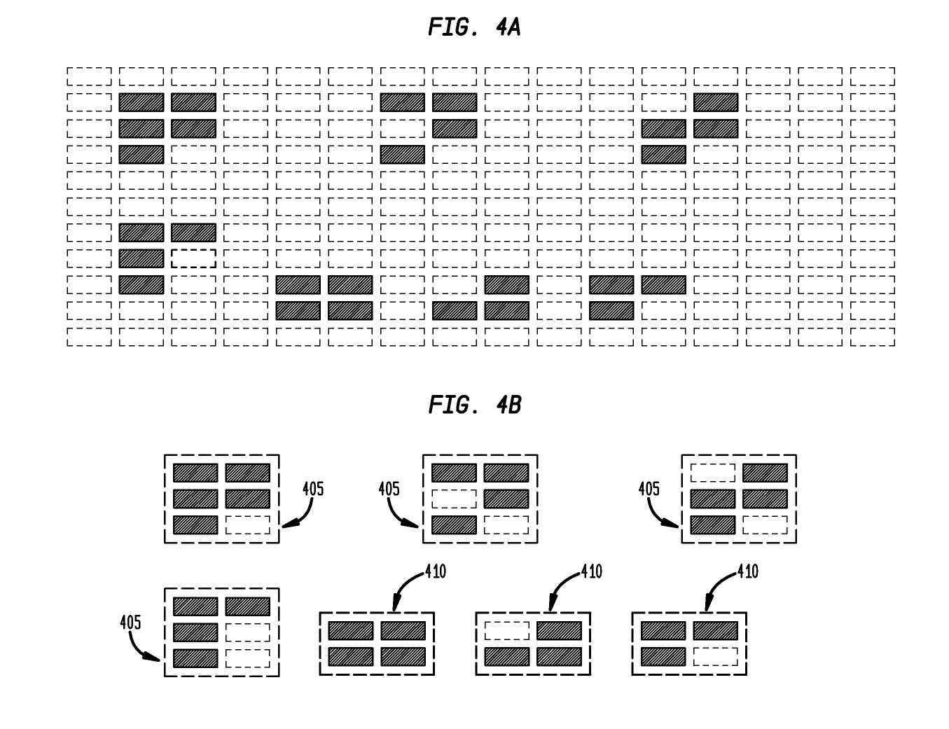

FIGS. 4A-4B illustrate an example of pattern splitting. When recognizing a single level pattern of features, it is likely that a maximal pattern will be found, meaning that all features falling on the theoretically infinite pattern grid will be included in a single pattern regardless of how far separated they may be.

FIG. 4A illustrates an example of feature groups in a large common grid. All the actual features in this example lie on the common grid, and so would be found as a single pattern in many implementations of single-level pattern recognition.

Disclosed embodiments can recognize the multi-level structure within this larger grid. After each use of the basic pattern recognition, the system can “split” the patterns using, in this example, an analysis of empty row and columns. In the example of FIG. 4A, this would split into seven patterns.

Having localized patterns by finding and splitting and having grouped them into ‘equal’ candidates, these first level patterns can then be abstracted as input to a further invocation of the single-level pattern recognition. FIG. 4B illustrates the resulting patterns. In this example, the system finds two patterns, a 3×2 pattern of patterns with two missing patterns shown at 405 (with missing patterns in the lower-middle and lower-right positions), and a 3×1 pattern of patterns shown at 410. Each of these feature patterns is similar to the example of FIG. 3D in that they show a strict geometric equivalence allowing missing features or sub-patterns within the pattern.

A high-level process for multi-level structure detection, corresponding to the more detailed process below, includes receiving a set of input features, and for each “equal” group, applying a single-level pattern recognition process, splitting detected patterns into localized patterns, and recursively performing the process using the detected patterns as the set of input features.

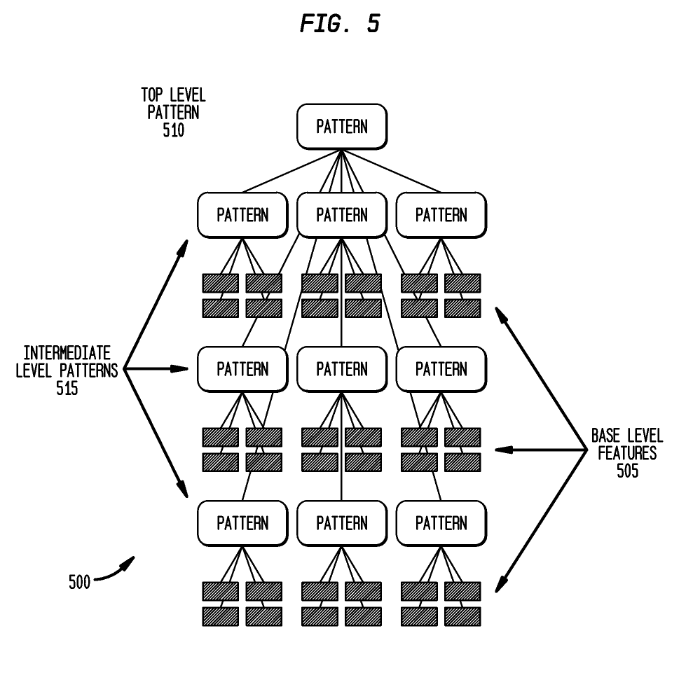

FIG. 5 illustrates a data structure representation of a multi-level pattern in accordance with disclosed embodiments. The data structure 500 uses a hierarchy from top level structure to base level features with multiple intermediate levels of structure in between. For example, in the simplest multi-level structure case of a ‘pattern of patterns’ and our proximity bias, the structure in the example of FIG. 2E can be represented as illustrated in FIG. 5.

As in FIG. 5, each of the base level features are analyzed to determine the intermediate level patterns 515 (the 2×2 patterns in FIG. 2E such as 210). These intermediate level patterns 515 are then analyzed to determine that they are arranged in a top level pattern 510. In this data structure, each of the base level features 505 is a leaf of an intermediate level pattern 515 node, which share a parent node for the top level pattern 510.

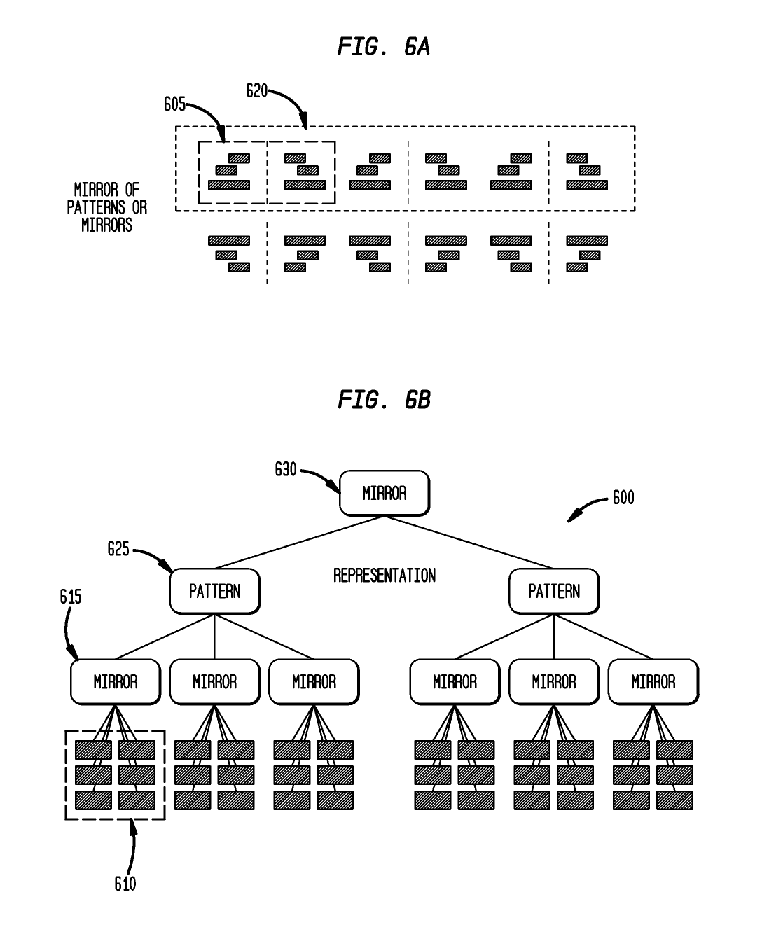

FIGS. 6A-6B illustrate a more complex multi-level structure in accordance with disclosed embodiments. FIG. 6A illustrates a multi-level mirror of patterns of mirrored features, and FIG. 6B illustrates a corresponding data structure representation as data structure 600. In these figures, the mirror of base level features as shown at 605 is represented by base features at 610 as leafs of the parent intermediate level mirror shown at 615. Three sets of these intermediate level mirrors, representing the “top” pattern as shown at 620, are represented by a pattern node at 625. Finally, both the pattern 625 and the mirrored “bottom” set of patterns shown in FIG. 6A are represented by a top-level mirror 630. Of course, the bottom set of patterns has a corresponding structure in the structure.

Handling the structure as a whole allows for more efficient processing of all the various structure elements and levels as one coherent object. It is often possible, for example, to disregard relationships between elements within the same structure and this benefit is magnified by using this larger overall representation. When considering the structure as a whole, it may often be desirable to consider only the boundary elements as interacting with the rest of the geometric environment, thus saving costly detection and processing of relationships involving the internal elements.

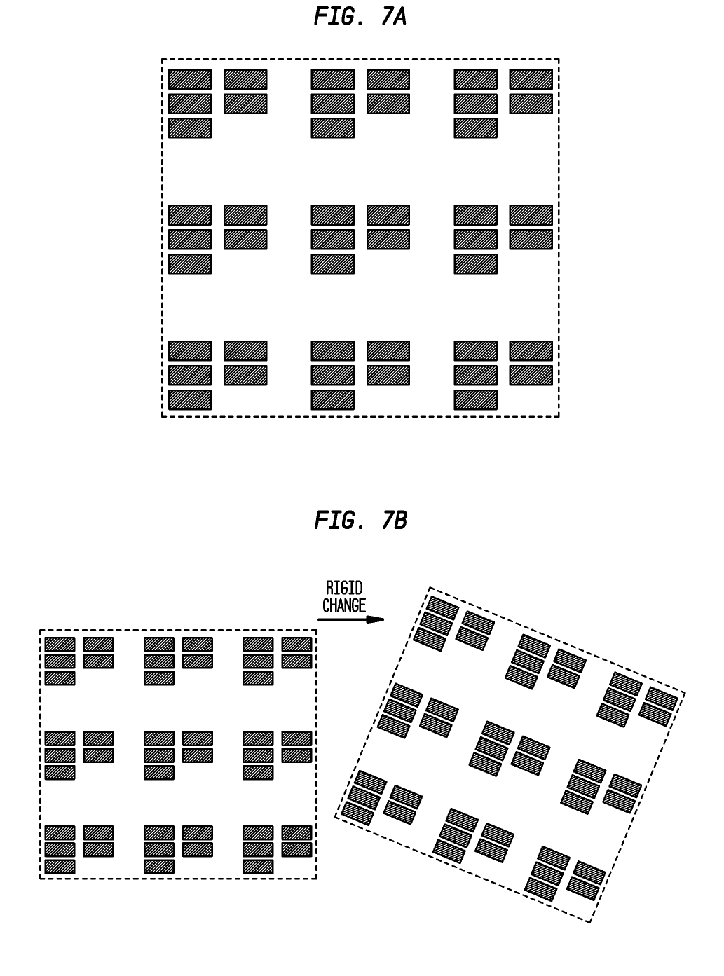

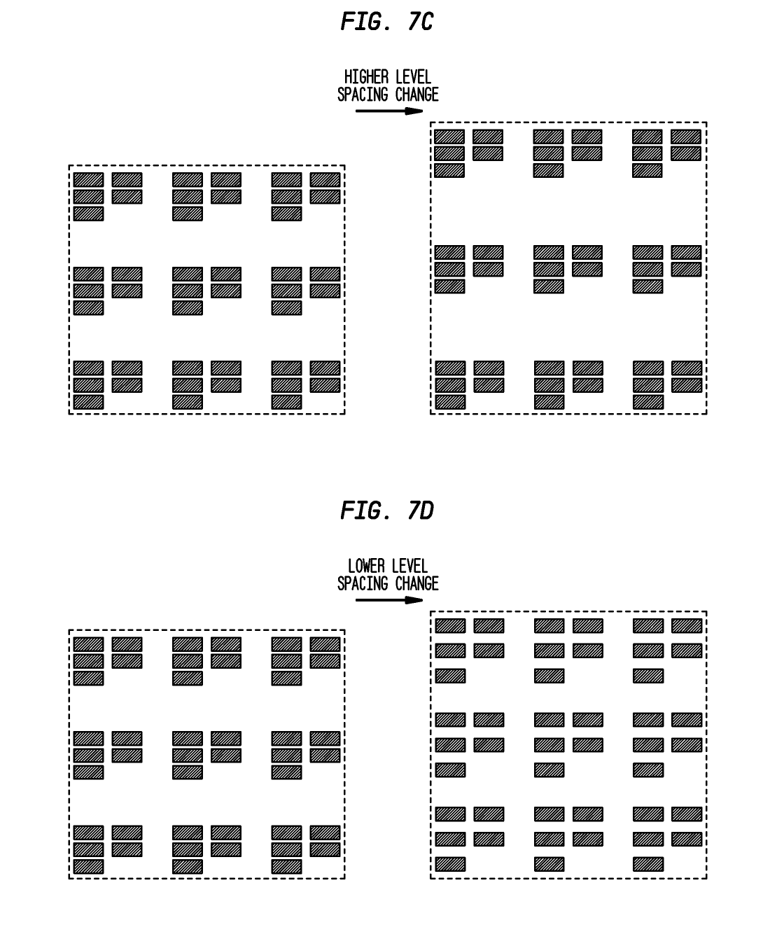

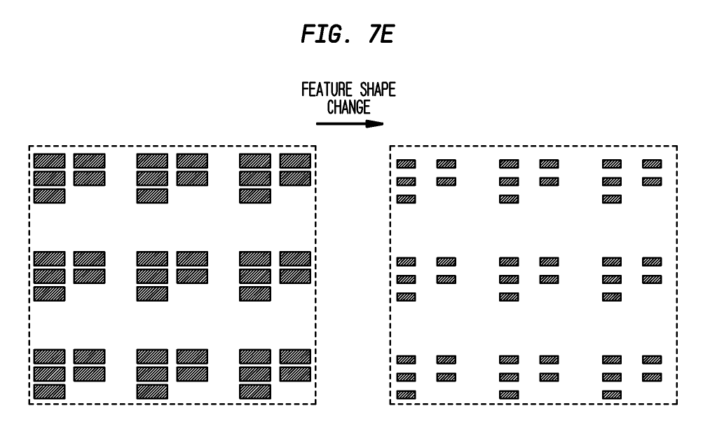

The behavior modes discussed herein are a naturally arising benefit from this choice of data structure representation. This representation also lends itself to clear graphical display to a user and it should be intuitive as it forms a bottom up/proximity based ordering of the geometric structure. FIGS. 7A-7E illustrate behavior modes in accordance with disclosed embodiments.

The system can implement different behavior modes for detected multi-level patterns. FIG. 7A illustrates an example of a higher level (3×3,X,Y) pattern with lower level identical (2×3,x,y) patterns with a single missing feature, where X,Y represents the spacing between the groups and x,y represents the spacing between the members of the groups.

There are a number of variables that can change including the shape of each feature, the four spacing values (X,Y,x,y) and the overall location and orientation of the whole. Allowing all or any combination of these to change in a single edit may produce much uncertainty and confusion for a user and the system. The solution, therefore, is to control the “modes” in which the structure is allowed to change. For this example, the modes are enumerated here:

FIG. 7B illustrates an “all rigid” behavior mode. In this mode all features are rigid, all spacings are constant and the effect is that the whole structure moves or rotates as one as illustrated.

FIGS. 7C-7D illustrates a “change spacing” behavior mode for a given level. Spacing change can be limited to one level in the data structure at a time, in which case the spacing for all levels above or below the given level are constant. The effect of this behavior mode is a “stretching” at the particular level. In this example there are two possible levels shown. Note that the figures show the y spacing changing in each case, where actually both x and y spacing may change together. FIG. 7C illustrates a higher-level spacing change, where the spacing between the lower-level patterns is changed, but the spacing within the lower-level patterns is constant. FIG. 7D illustrates a lower-level spacing change, where the spacing between the basic features in each lower level pattern is changed but the spacing between the lower level patterns is constant.

FIG. 7E illustrates a “change feature shape” behavior mode. In this mode all features are fixed in location but can vary in shape or size. All spacings are fixed. In FIG. 7E, each of the basic feature elements and each of the patterns are kept in the same location and spacing, but the size of each of the features is changed.

The choice of behavior mode can be explicitly selected by a user and received by the system, or can be heuristically chosen by the system based on the selected element or elements and various other contextual and domain specific preferences.

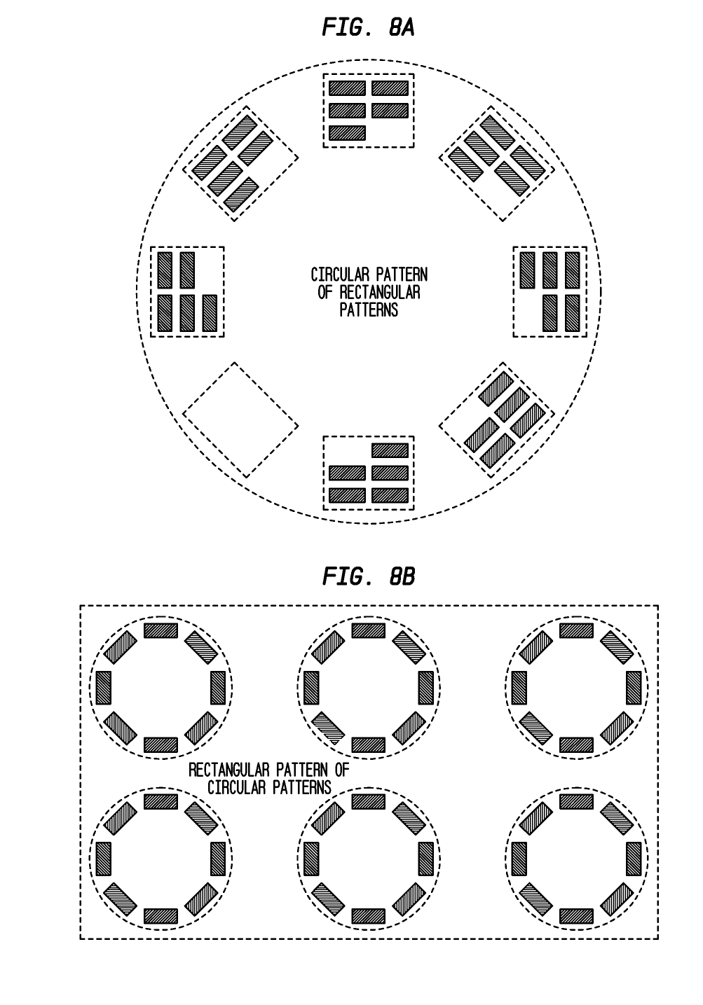

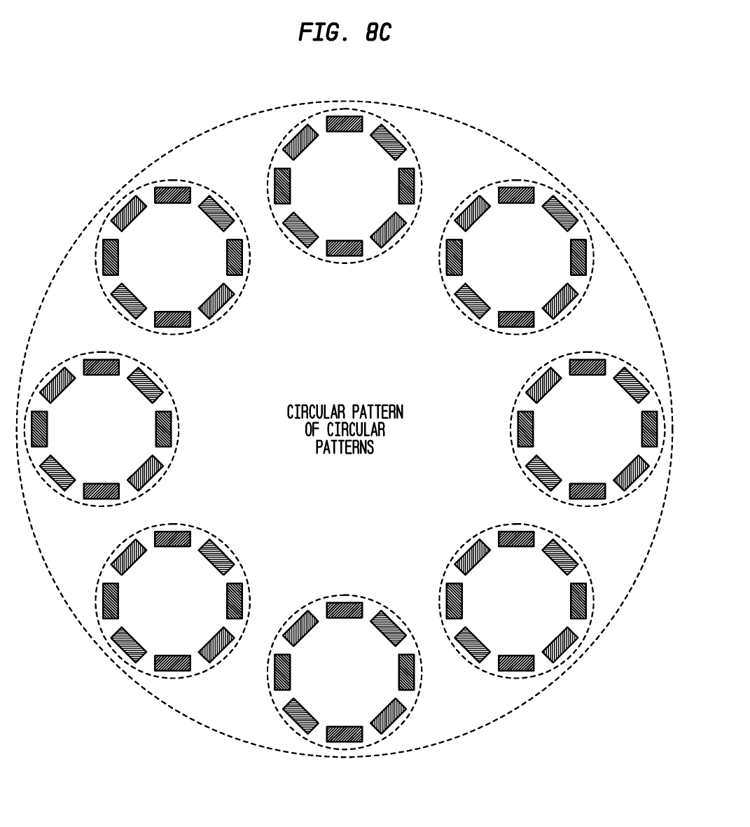

The examples above have focused on rectangular grid patterns, but the processes and techniques described herein apply as well to linear patterns, circular patterns, mirrors etc. FIGS. 8A-8C illustrate examples of multi-level patterns incorporating these types of structures. FIG. 8A illustrates a circular pattern of rectangular patterns; FIG. 8B illustrates a rectangular pattern of circular patterns; and FIG. 8C illustrates a circular pattern of circular patterns.

Disclosed embodiments can evaluate circular pattern alignment. When considering whether two circular patterns are equal, the alignment should be considered. In a geometric interpretation the alignments should match. The matching of alignments depends on which type of higher level pattern is being considered.

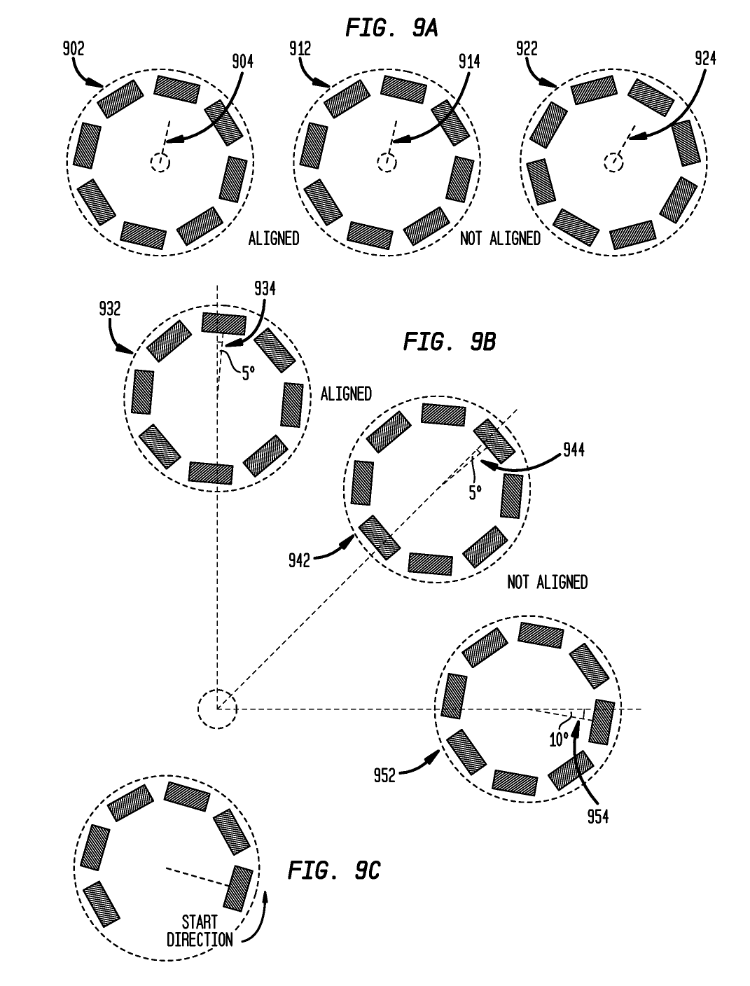

FIGS. 9A-9C illustrate alignment in circular patterns. When considering a rectangular pattern of circular patterns, the most parallel pair of radial vectors is used to determine alignment. FIG. 9A illustrates alignment and non-alignment of circular patterns. In FIG. 9A, pattern 902 is considered aligned with pattern 912 since radial vector 904 is aligned with radial vector 914. Pattern 912 is considered not aligned with pattern 922 since radial vector 914 is not aligned with radial vector 924.

When considering a circular pattern of circular patterns, the pair of radial vectors most parallel to the higher level radial vector is used. In FIG. 9B, pattern 932 is considered aligned with pattern 942 since radial vector 934 and radial vector 944 are both 5 degrees from the higher-level radial vector. Pattern 942 is considered not aligned with pattern 952 since radial vector 944 and radial vector 954 have different radial offsets from the higher-level radial vector.

The alignment techniques described above apply to closed patterns where an exact number of spacing angles fit into 360 degrees. When this is not true, the pattern is called “open” and will have a definite start direction. The start direction can be used for the alignment check if geometric equality is required. FIG. 9C illustrates a start direction of an open circular pattern.

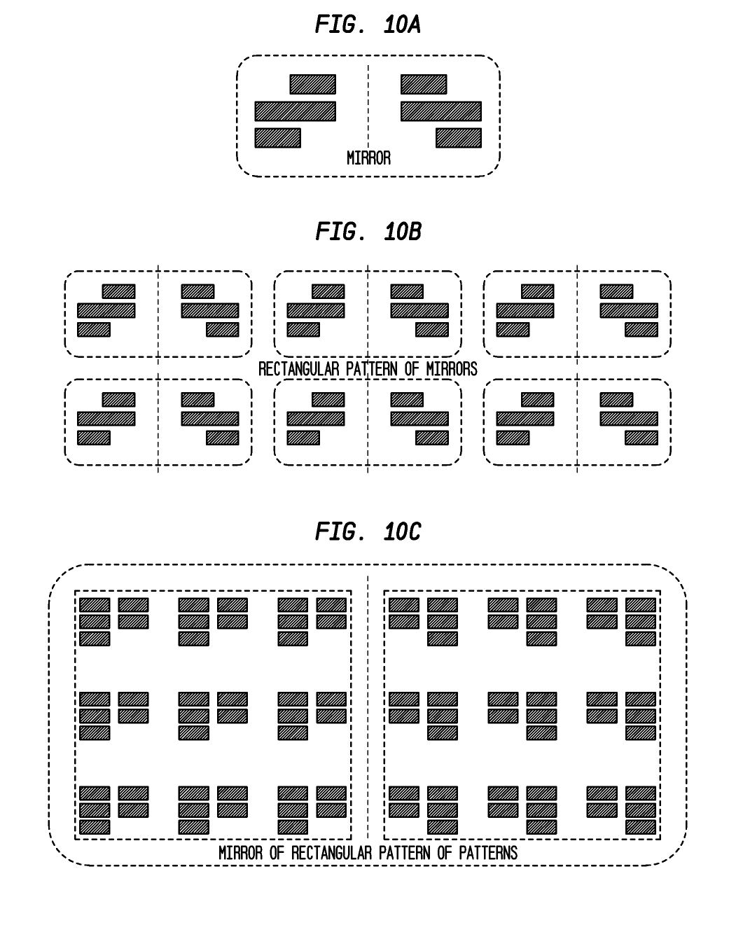

FIGS. 10A-10C illustrate examples including mirrors. FIG. 10A illustrates a mirror between the left and right features. FIG. 10B illustrates a rectangular pattern of mirrors, where mirrors are arranged in a rectangular pattern. FIG. 10C illustrates a mirror of rectangular pattern of patterns, where the left side is a mirror of the right side, and each side is a higher-level pattern of lower-level patterns of features.

The use of proximity in grouping structure extends to circular patterns and mirrors and further into other structure forms as does the efficiency and behavior control that the overall framework offers.

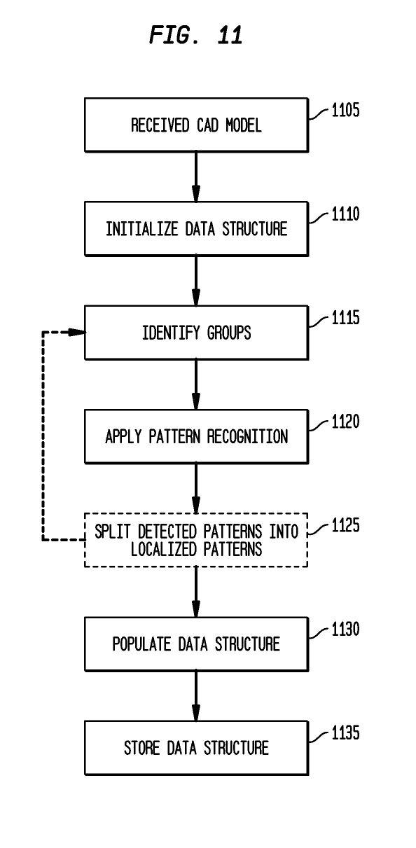

FIG. 11 depicts a flowchart of a process in accordance with disclosed embodiments that may be performed, for example, by one or more CAD systems as described herein, referred to generically as the “system.”

The system receives a CAD model including a plurality of input features (1105). Receiving, as used herein, can include loading from storage, receiving from another device or process, receiving via an interaction with a user, receiving from a previous iteration of this process, and otherwise. The features can be arranged in 2D or 3D.

The system initializes a data structure representing multi-level structure in the input CAD model (1110).

The system identifies at least two equal groups of the plurality of input features (1115). Equal groups, as described herein, can include groups of features that have notional centers that lay in a pattern, groups of features that are arranged in common form, even if one or more individual features are missing from a given form for example with full group alignment and equal boundary size, and otherwise as described herein. This identification can used techniques as described herein, including finding mirrored elements, aligned circles of elements, and others.

The system applies a single-level structure-recognition process on the groups of features to produce detected structures (1120). The structure can include mirror patterns, grid patterns, circular patterns, or multi-level combinations of these.

The system can optionally split any detected patterns into localized patterns (1125) and recursively perform steps 1115-1120 using the detected structures as input features. This recursion can produce additional multi-level structure such as patterns-of-patterns to be used in the data structure. The recursion can be repeated multiple times until no more structures are detected.

The system populates the data structure (1130). The data structure includes leaf nodes representing input features, intermediate nodes representing structures such as patterns of the input features, and a top-level node identifying the top-level structure of intermediate-node structures discovered in the CAD model. Multiple levels of intermediate nodes can be included, for example identifying higher- and lower-level sub-structures in the CAD model.

The system stores the data structure as associated with the CAD model (1135). The data structure can thereafter be used to modify the CAD model using the structures identified by the data structure, including using the behavior modes described herein.

Of course, those of skill in the art will recognize that, unless specifically indicated or required by the sequence of operations, certain steps in the processes described above may be omitted, performed concurrently or sequentially, or performed in a different order.

Techniques disclosed herein are extended in some embodiments to include such features as general instancing of any application features (i.e., not pattern or mirror, but the instances are the same), general instancing of a group of faces, mixed nodes, where features of different types and entities (faces) are within a node, and other types of patterns such as skew rectangular, radial, cylindrical, helical, etc.

Multiple level patterns and structures are common and rapidly create difficult and inefficient systems for synchronous technology to handle, resulting in poor performance in current systems. The ability to recognize and structure multi-level structures such as patterns as disclosed herein provides the distinct technical advantage of more efficient and uniform processing of such structures.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method performed by a data processing system, comprising:
receiving a CAD model including a plurality of input features;
initializing a data structure representing multi-level structures in the CAD model;
identifying at least two equal groups of the plurality of input features;
applying a single-level structure recognition process on the groups of features to produce detected structures;
populating the data structure according to the detected structures; and
storing the data structure as associated with the CAD model.

2. The method of claim 1, wherein the system also splits the detected structures into localized structures and repeats the identifying and applying processes using the detected structures as input features.

3. The method of claim 1, wherein the data structure includes leaf nodes representing input features, intermediate nodes representing structures of the input features, and a top-level node identifying a top-level structure of intermediate-node structures discovered in the CAD model.

4. The method of claim 1, wherein the detected structures include mirror structures, grid structures, circular structures, or multi-level combinations of structures.

5. The method of claim 1, wherein the equal groups include groups of features that have notional centers that lay in a structure.

6. The method of claim 1, wherein the equal groups include groups of features that have a common group alignment and an equal boundary size.

7. The method of claim 1, wherein the data structure includes multiple levels of intermediate nodes representing structures.

8. A data processing system comprising:
a processor; and
an accessible memory, the data processing system particularly configured to receive a CAD model including a plurality of input features;
initialize a data structure representing multi-level structures in the CAD model;
identify at least two equal groups of the plurality of input features;
apply a single-level structure recognition process on the groups of features to produce detected structures;
populate the data structure according to the detected structures; and
store the data structure as associated with the CAD model.

9. The data processing system of claim 8, wherein the system also splits the detected structures into localized structures and repeats the identifying and applying processes using the detected structures as input features.

10. The data processing system of claim 8, wherein the data structure includes leaf nodes representing input features, intermediate nodes representing structures of the input features, and a top-level node identifying a top-level structure of intermediate-node structures discovered in the CAD model.

11. The data processing system of claim 8, wherein the detected structures include mirror structures, grid structures, circular structures, or multi-level combinations of structures.

12. The data processing system of claim 8, wherein the equal groups include groups of features that have notional centers that lay in a structure.

13. The data processing system of claim 8, wherein the equal groups include groups of features that have a common group alignment and an equal boundary size.

14. The data processing system of claim 8, wherein the data structure includes multiple levels of intermediate nodes representing structures.

15. A non-transitory computer-readable medium encoded with executable instructions that, when executed, cause one or more data processing systems to:
receive a CAD model including a plurality of input features;
initialize a data structure representing multi-level structures in the CAD model;
identify at least two equal groups of the plurality of input features;
apply a single-level structure recognition process on the groups of features to produce detected structures;
populate the data structure according to the detected structures; and
store the data structure as associated with the CAD model.

16. The computer-readable medium of claim 15, wherein the system also splits the detected structures into localized structures and repeats the identifying and applying processes using the detected structures as input features.

17. The computer-readable medium of claim 15, wherein the data structure includes leaf nodes representing input features, intermediate nodes representing structures of the input features, and a top-level node identifying a top-level structure of intermediate-node structures discovered in the CAD model.

18. The computer-readable medium of claim 15, wherein the detected structures include mirror structures, grid structures, circular structures, or multi-level combinations of structures.

19. The computer-readable medium of claim 15, wherein the equal groups include at least one of groups of features that have notional centers that lay in a structure and groups of features that have a common group alignment and an equal boundary size.

20. The computer-readable medium of claim 15, wherein the data structure includes multiple levels of intermediate nodes representing structures.
